(19) United States
(12) Patent Application Publication
(10) Pub. No.: US 2025/0192539 A1
(43) Pub. Date: Jun. 12, 2025

(54) INRUSH CURRENT PREVENTION APPARATUS, CONTROL APPARATUS, AND INRUSH CURRENT PREVENTION METHOD

(71) Applicant: NIPPON TELEGRAPH AND TELEPHONE CORPORATION, Tokyo (JP)

(72) Inventors: Naoki HANAOKA, Tokyo (JP); Toru TANAKA, Tokyo (JP); Naomichi NAKAMURA, Tokyo (JP); Yuji HIGUCHI, Tokyo (JP)

(73) Assignee: NIPPON TELEGRAPH AND TELEPHONE CORPORATION, Tokyo (JP)

(21) Appl. No.: 18/844,834

(22) PCT Filed: Mar. 18, 2022
(86) PCT No.: PCT/JP2022/012900

§ 371 Date: Sep. 6, 2024

(51) Int. Cl. H02H 3/087

(52) U.S. Cl. CPC H02H 3/087

(57) ABSTRACT

An inrush current prevention apparatus used in a specific base in a DC power supply system, the DC power supply system including multiple bases each having a power supply device and being connected by a power supply line, the inrush current prevention apparatus comprising: a switching unit; a current reduction unit connected in parallel with the switching unit; a processor; and a memory storing instructions that cause the processor to execute a process including bringing the switching unit into a connected state when the specific base is supplying power, wherein when a predetermined current occurs between a power supply device in the specific base and a power supply device in another base, by bringing the switching unit into a disconnected state, a current between the power supply device in the specific base and the power supply device in the other base is caused to flow to the current reduction unit.

### TECHNICAL FIELD

The present invention relates to a technique for preventing an inrush current.

### BACKGROUND ART

In communication buildings, data centers, and the like, direct current (DC) power supply systems at a high voltage have been introduced for the purpose of reducing power loss of the entire system and achieving energy saving. A DC power supply system supplies power (distributes power) at a high voltage such as 380 V, for example.

In a conventional DC power supply system, power supply is generally performed indoors. In an indoor DC power supply system, power supply is performed with a cable of about 60 m at the maximum. In addition, the direction of power supply is one direction to a load such as an ICT device.

### CITATION LIST

### Non Patent Literature

Non Patent Literature 1: IEEJ2021 General Lecture 6-056, “Study on Short Circuit Protection of Outdoor DC Power Supply System”, Hanaoka et al.

### SUMMARY OF INVENTION

### Technical Problem

In the future, it is assumed that an outdoor DC power supply system that performs DC power supply using an outdoor power supply line is introduced (for example, Non Patent Literature 1). In addition, it is assumed that, in one form, a plurality of bases having a power supply converter are connected in n to n and bidirectional power supply is performed between the bases.

In an outdoor DC power supply system, there is a case where power is supplied to a load located several kilometers away (for example, up to 4 km). In this case, the impedance (resistance component, inductance component) becomes very large compared to the conventional indoor DC power supply system.

In a situation where a plurality of bases each having a power supply converter are connected n to n, it is conceivable that a scene in which a base is newly added to a trunk line in a power supply state occurs, and there is a problem that an inrush current flows at the time of adding a base, and the power supply converter in the base that is supplying power stops.

The present invention has been made in view of the above points, and an object of the present invention is to provide a technique for preventing an inrush current in a DC power supply system in which a plurality of bases are connected by a power supply line.

### Solution to Problem

With the disclosed technique, an inrush current prevention apparatus used in a specific base in a DC power supply system, the DC power supply system including a plurality of bases, the plurality of bases each having a power supply device and being connected by a power supply line is provided, the inrush current prevention apparatus including:
a switching unit configured to be in a connected state when the specific base is supplying power; and
a current reduction unit connected in parallel with the switching unit, in which
when a predetermined current has occurred between a power supply device in the specific base and a power supply device in another base, by bringing the switching unit into a disconnected state, a current between the power supply device in the specific base and the power supply device in the other base is caused to flow to the current reduction unit.

### Advantageous Effects of Invention

With the disclosed technique, it is possible to prevent an inrush current in a DC power supply system in which a plurality of bases are connected by a power supply line.

### BRIEF DESCRIPTION OF DRAWINGS

FIG. 1 is a diagram illustrating an overall configuration example of a DC power supply system.

FIG. 2 is a diagram illustrating a configuration example of a DC power supply system in a building.

FIG. 3 is a diagram illustrating an example of a DC power supply system that connects bases by an outdoor power supply line.

FIG. 4 is a diagram for illustrating a problem and a solution to the problem.

FIG. 5 is a diagram illustrating a voltage waveform when an inrush current occurs.

FIG. 6 is a diagram for illustrating a problem and a solution to the problem.

FIG. 7 is a diagram for illustrating a conventional inrush current prevention circuit.

FIG. 8 is a diagram illustrating an operation of an inrush current prevention apparatus.

FIG. 9 is a diagram illustrating an operation of the inrush current prevention apparatus.

FIG. 10 is a diagram illustrating a configuration example of the inrush current prevention apparatus.

FIG. 11 is a diagram illustrating a configuration example of a control apparatus.

FIG. 12 is a diagram illustrating a configuration example of the inrush current prevention apparatus.

FIG. 13 is a diagram illustrating an example of a DC power supply system that connects bases by an outdoor power supply line.

FIG. 14 is a diagram illustrating an area to which a countermeasure by the inrush current prevention apparatus needs to be applied.

FIG. 15 is a diagram illustrating an example of a hardware configuration of the device.

### DESCRIPTION OF EMBODIMENTS

An embodiment of the present invention (present embodiment) will be described below with reference to the drawings. The embodiment described below is merely an example, and embodiments to which the present invention is applied are not limited to the following embodiment.

### (Overall Configuration Example of System)

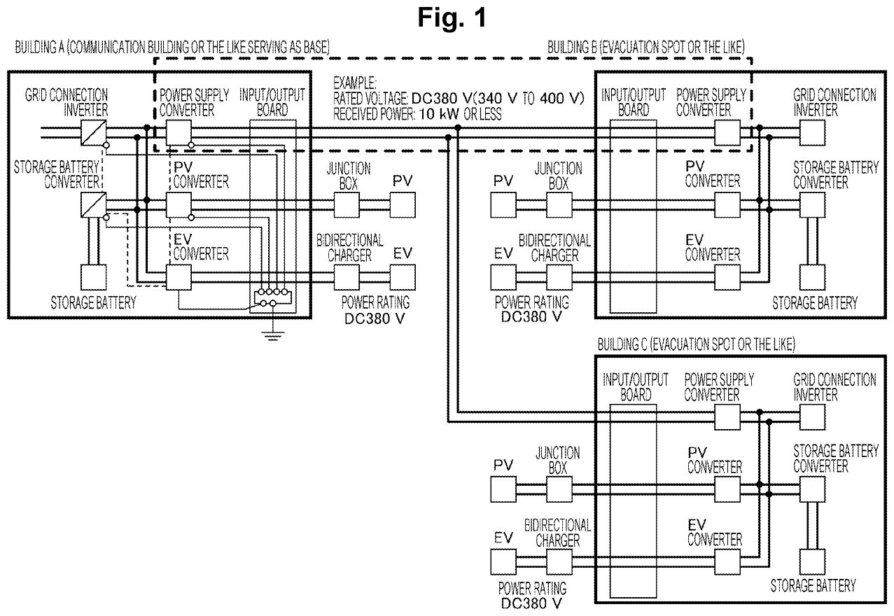

FIG. 1 illustrates an overall configuration example of a DC power supply system according to the present embodiment. In the DC power supply system illustrated in FIG. 1, power is supplied over a long distance (for example, about 4 km) at a high voltage (for example, 380 V) by an outdoor power supply line.

In the example of FIG. 1, there are three bases, more specifically, a building A, a building B, and a building C, and each building includes a power supply converter and can supply power to the other buildings. That is, bidirectional power supply can be performed between any two bases of the three bases. In the example of FIG. 1, the building A is a building, such as a communication building, serving as a base, and the building B and the building C are buildings such as evacuation spots. The power supply converter may be referred to as power supply device. However, the “power supply device” is not limited to a power supply converter.

As illustrated in FIG. 1, each base is provided with a power generation facility such as a solar power generator (PV) and a wind power generation, and a load such as an EV and a storage battery, and can perform power interchange between the bases bidirectionally by the converters.

### Problem and Solution

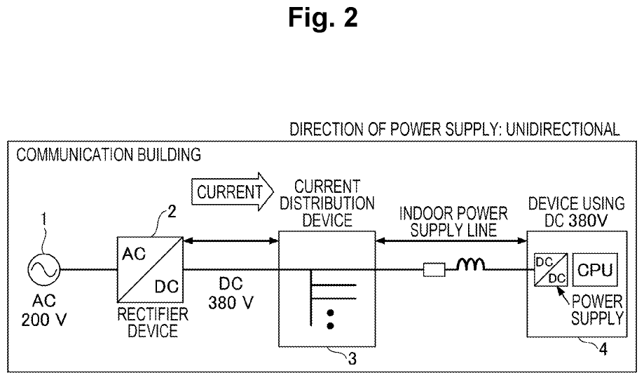

Hereinafter, problems to be solved by the technique according to the present invention will be described in detail. First, for comparison, FIG. 2 illustrates an example of a conventional indoor (in a communication building) DC power supply system. As illustrated in FIG. 2, the DC power supply system includes an AC 200 V 1, a rectifier device 2, a current distribution device 3, and a load 4 (a device using DC 380 V).

As illustrated in FIG. 2, unidirectional power supply from the rectifier device 2 to the load 4 is performed by a cable of about 60 m at the maximum. Therefore, power can be stably transmitted to the load 4 such as the ICT device.

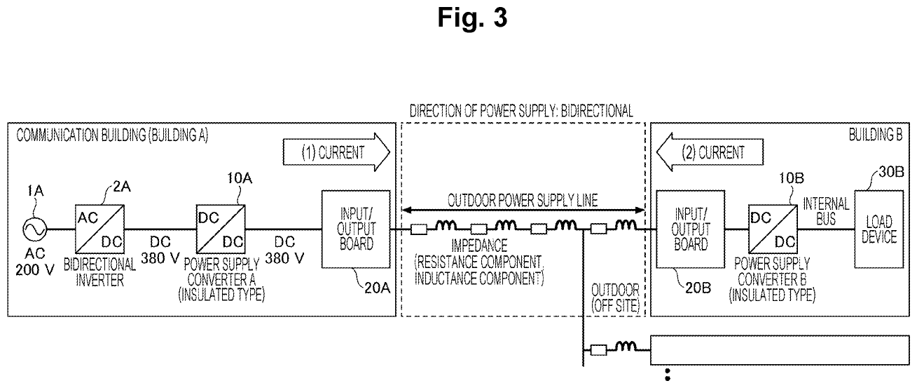

FIG. 3 illustrates the DC power supply system corresponding to a portion in a frame surrounded by a dotted line in FIG. 1. As illustrated in FIG. 3, the building A (communication building) includes a power supply 1A of AC 200 V, a bidirectional inverter 2A, a power supply converter A (10A), and an input/output board 20A. In addition, the building B includes an input/output board 20B, a power supply converter 10B, and a load device 30B.

The building A and the building B are connected by the outdoor power supply line that is capable of bidirectional power supply and has a length of, for example, 4 km at the maximum.

When power is supplied over a long distance as in the configuration of FIG. 3, the impedance (a resistance component, an inductance component) is about two orders of magnitude larger than the impedance in the configuration illustrated in FIG. 2.

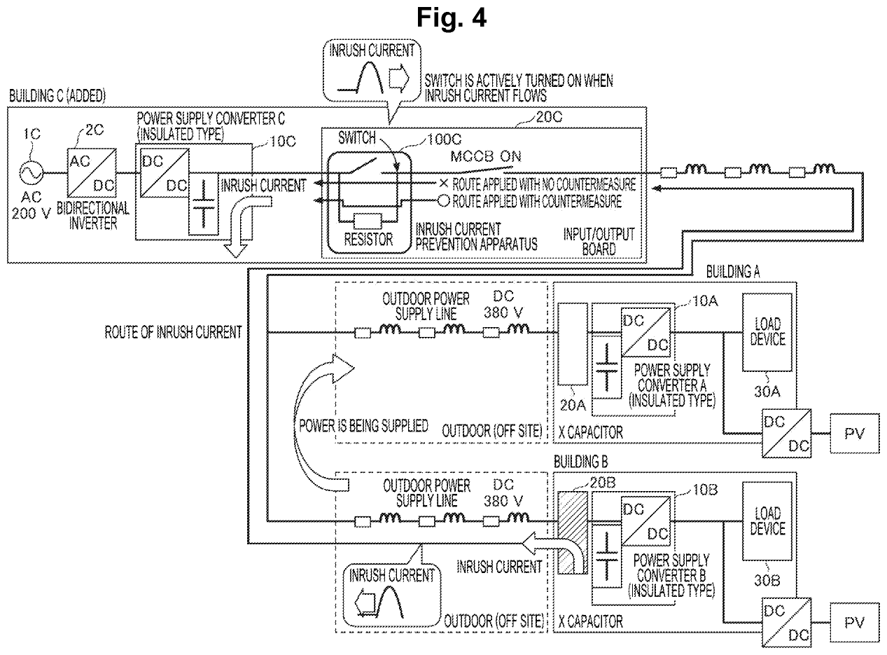

An outline of a problem occurring in the long-distance power supply as described above and a solution to the problem will be described with reference to FIG. 4. FIG. 4 illustrates an example of a case where a power supply device of the building C is added while the power is being supplied from the building B to the building A. Each of the buildings A and B is provided with a solar power generator (photovoltaic: PV). That is, an example of a case where the power supply device of the building C is added to the trunk line that is supplying power in the DC power supply system including the power supply device of the building A and the power supply device of the building B is illustrated. Note that, in the present embodiment, that a certain base is supplying power includes both meaning that the base is supplying power to another base and meaning that the base is receiving power supply from another base.

Each building is provided with a power supply converter 10, and FIG. 4 illustrates an X capacitor in the power supply converter. The X capacitor is a capacitor connected between the wires in the power supply line.

An input/output board 20C of the building C in FIG. 4 is provided with an inrush current prevention apparatus 100C, which is the technique according to the present invention. First, the problem that occurs when the inrush current prevention apparatus 100C is not provided will be described. The route of the current when the inrush current prevention apparatus 100C is not provided is illustrated in FIG. 4 as “route applied with no countermeasure”.

In FIG. 4, when the power supply device of the building C is added while the power is being supplied from the building B to the building A, a power supply converter 10C of the building C is turned on, and thereafter, molded case circuit breaker (MCCB) is turned on. Note that the MCCB is a circuit breaker for wiring, and when the MCCB is turned on, a current flows, and when the MCCB is turned off, the wiring is cut.

When there is no inrush current prevention apparatus 100C, an inrush current flows between the building C and the building B by turning on the MCCB. The inrush current is generally a large current that temporarily flows when the power of the electric device is turned on. This inrush current occurs when a current flows from the X capacitor on the output side of the power supply converter B into the X capacitor added in the building C.

As described above, since the length of the power supply line (cable) is long, the impedance of the power supply line is very large. Therefore, the voltage (voltage between the positive electric wire and the negative electric wire) is greatly decreased by the inrush current, and the power supply converter 10C is stopped by output under voltage protection (UVP) or the like. Similarly, the power supply converter 10B of the building B is also stopped. That is, there is a possibility that the entire outdoor power supply line fails because of the influence of the inrush current.

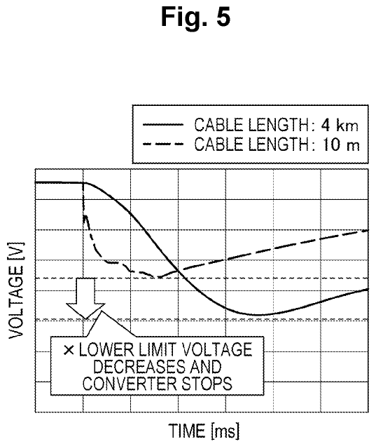

FIG. 5 is a diagram comparing voltage waveforms at the time of occurrence of inrush current when a cable length is short (10 m) and when the cable length is long (4 km). As illustrated in FIG. 5, when the cable length is long, the voltage decreases more greatly. Therefore, the power supply converter stops. In addition, since a large current flows, a fuse provided in an input/output board or the like may be fused.

Note that, although there is no problem in the case of long-distance power supply on a one-to-one basis (unidirectional basis), this problem occurs in a scene where a power supply facility is newly added to the trunk line in the power supply state in the bidirectional n-to-n long-distance outdoor power supply.

In order to prevent the inrush current as described above, in the present embodiment, as illustrated in FIG. 4, the inrush current prevention apparatus 100C is provided in the input/output board 20C of the building C. The inrush current prevention apparatus 100C includes a switch and a resistor. Normally, the switch is turned on, and a current flows without passing through the resistor. When an inrush current occurs, the switch is turned off, and the current passes through the resistor, so that the inrush current can be prevented.

The inrush current prevention apparatus 100 are also provided in the building A and the building B. However, in the example of FIG. 4, no inrush current prevention apparatus 100 may be provided in the building A as a core.

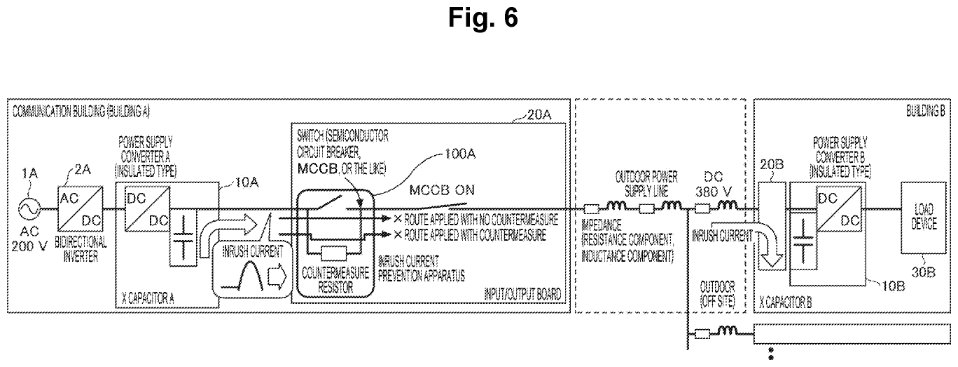

FIG. 6 is a diagram illustrating another example of a situation in which an inrush current occurs. FIG. 6 illustrates an example of a case where a power supply device of the building B is added while the power is being supplied from the building A to the building C. Similarly to the case of FIG. 4, in a case where an inrush current prevention apparatus 100A is not provided, an inrush current flows when the MCCB in the building B is turned on, and the power supply converter 10A and the power supply converter 10B are stopped. This inrush current occurs when a current flows from the X capacitor on the output side of the power supply converter A into the X capacitor added in the building B.

In order to prevent an inrush current, as in the case of FIG. 4, the inrush current prevention apparatus 100A is externally provided separately from the power supply converter. With the inrush current prevention apparatus 100A, when an inrush current occurs, a resistor having a specific magnitude can be inserted into the current, and the power supply converter 10A can stably start.

### (Detail of Operation)

Here, an operation of the inrush current prevention apparatus 100 of the present embodiment will be described in more detail using comparison with a conventional technique.

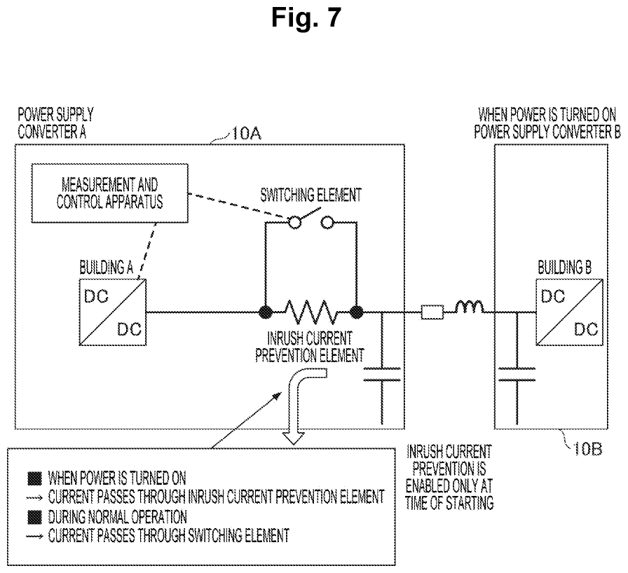

In the conventional technique, an inrush current prevention circuit is incorporated in a power supply converter. An example is illustrated in FIG. 7. FIG. 7 illustrates the power supply converter 10A and the power supply converter 10B, and the internal configuration of the power supply converter 10A is illustrated.

As illustrated in FIG. 7, the power supply converter 10A includes an inrush current prevention element (resistor) and a switching element as the inrush current prevention circuit. In the conventional technique, when the power of the power supply converter 10A is turned on, a measurement and control apparatus detects the turning on and turns off the switching element to prevent an inrush current. Normally, the switching element is turned on, and a current flows without passing through the inrush current prevention element (resistor).

However, since there is the X capacitor on the output side of the power supply converter 10A, the inrush current cannot be suppressed by the mechanism illustrated in FIG. 7 in the situation illustrated in FIG. 6. That is, since the switch remains turned on during the normal operation, the inrush current (charge) flowing out to the building B cannot be prevented.

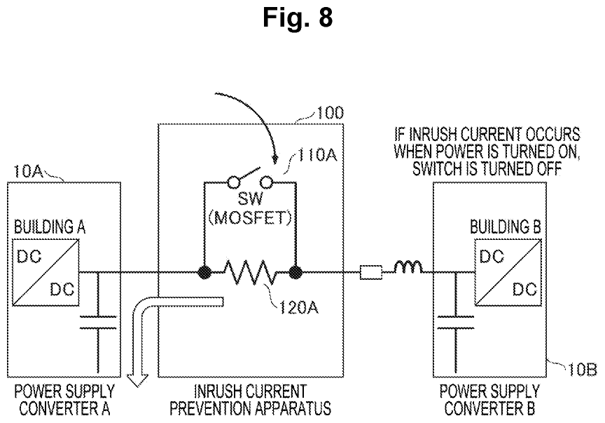

Hereinafter, the operation of the inrush current prevention apparatus 100 according to the present embodiment for solving the above problems will be described. Here, an operation of the inrush current prevention apparatus 100A in the building A will be described as an example. First, the operation of the inrush current prevention apparatus 100A when the power of the power supply converter 10A is turned on will be described with reference to FIG. 8.

As illustrated in FIG. 8, the inrush current prevention apparatus 100A includes a switching element 110A and an inrush current prevention element 120A (resistor), which are connected in parallel with each other. When the power supply converter 10A is turned from off to on, accumulation of charges in the X capacitor is started, so that a current flows in the illustrated direction. When detecting an inrush current (start of accumulation of charges in the X capacitor) with a current sensor described later, the inrush current prevention apparatus 100A turns off the switching element 110A so that the current flows through the inrush current prevention element 120A (resistor). This makes it possible to prevent the inrush current.

As illustrated in FIG. 8, since the inrush current prevention apparatus 100A can prevent an inrush current at the time of turning on the power, which is also possible in the conventional technique, by providing the inrush current prevention apparatus 100A, a conventional inrush current prevention circuit may be omitted. That is, the device (circuit) can be shared.

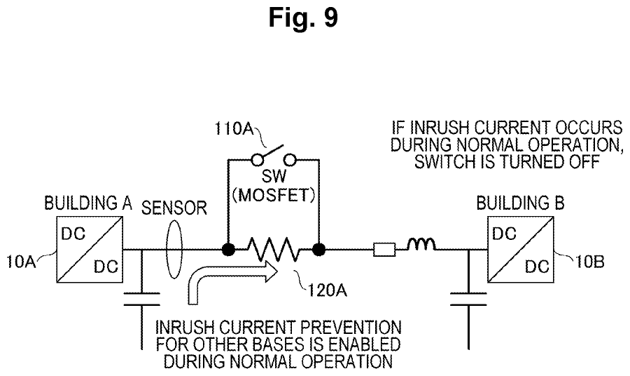

Next, the operation of the inrush current prevention apparatus 100A when an inrush current is detected during normal operation will be described with reference to FIG. 9. Here, power is being supplied from the building A to the building B, and the switching element 110A is turned on.

It is assumed that a power supply device is added in a building C, which is another building, and the power of the building C is turned on. In this case, an inrush current (rapid change in current) from the inside to the outside occurs in the building A. When a current sensor 130A detects this change, the switching element 110A is turned off, and the current is caused to flow to the inrush current prevention element 120A. As a result, the inrush current can be prevented.

The sensor 130A may be provided in the power supply converter 10A or may be provided in the inrush current prevention apparatus 100A.

### (Configuration Example of Inrush Current Prevention Apparatus 100)

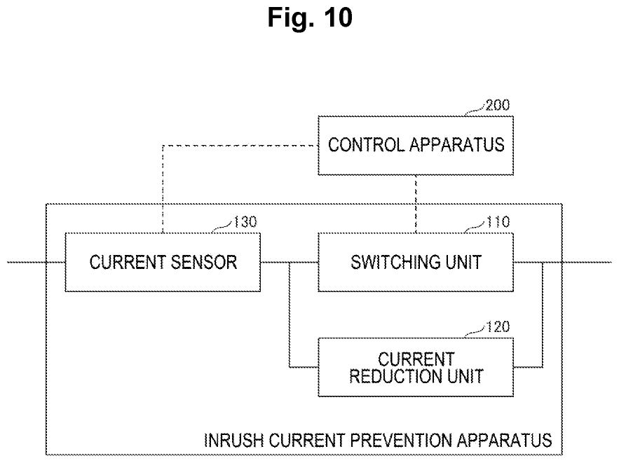

FIG. 10 is a diagram illustrating a configuration example of the inrush current prevention apparatus 100. As illustrated in FIG. 10, the inrush current prevention apparatus 100 includes a switching unit 110, a current reduction unit 120, and a current sensor 130. A control apparatus 200 is connected to the inrush current prevention apparatus 100. Note that the current sensor 130 may be provided outside the inrush current prevention apparatus 100. In addition, the control apparatus 200 may be provided inside the inrush current prevention apparatus 100.

The switching unit 110 is turned off when an inrush current is detected by the current sensor 130, and is turned on otherwise. The current reduction unit 120 is a portion that reduces the current and allows the current to flow when the switching unit 110 is turned off. The current sensor 130 measures a current flowing through the electric wire.

After the inrush current is settled, the switching unit 110 is turned on so that a current does not flow in the current reduction unit 120.

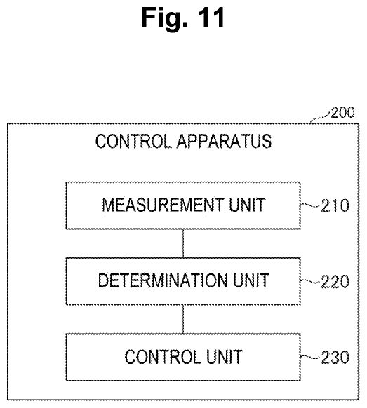

FIG. 11 illustrates a configuration example of the control apparatus 200. As illustrated in FIG. 11, the control apparatus 200 includes a measurement unit 210, a determination unit 220, and a control unit 230. The measurement unit 210 acquires a measurement result (current value) measured by the current sensor 130.

The determination unit 220 determines whether an inrush current has occurred based on the current value measured by the current sensor 130. For example, the inrush current is determined to have occurred when the increased amount of the current value per unit time (the change amount of the current value) is larger than a threshold.

When the determination unit 220 determines that an inrush current has occurred, the control unit 230 instructs the switch 110 to turn off.

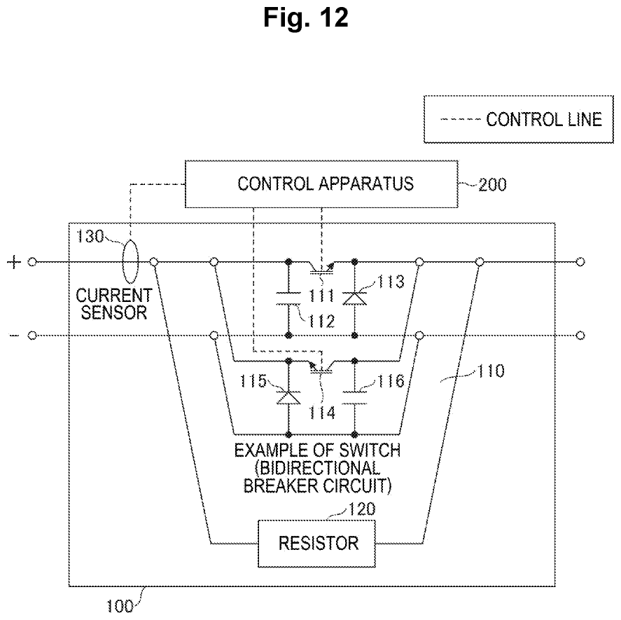

FIG. 12 is a diagram illustrating a more specific configuration example of the inrush current prevention apparatus 100. In the example illustrated in FIG. 12, a resistor is used as the current reduction unit 120. As the switching unit 110 (switch), a circuit including transistors 111 and 114, diodes 113 and 115, and capacitors 112 and 116 is used.

### (Determination for Necessity of Inrush Current Prevention Apparatus 100)

The inrush current prevention apparatus 100 can be attached, for example, in the input/output board 20 as an external device. In addition, when the outdoor power supply line is short or when the capacitance of the X capacitor is low, the inrush current prevention apparatus 100 may be unnecessary. Therefore, it is not necessary to provide the inrush current prevention apparatus 100 in all the buildings, and it is sufficient to provide the inrush current prevention apparatus 100 only in a building that needs the inrush current prevention apparatus 100.

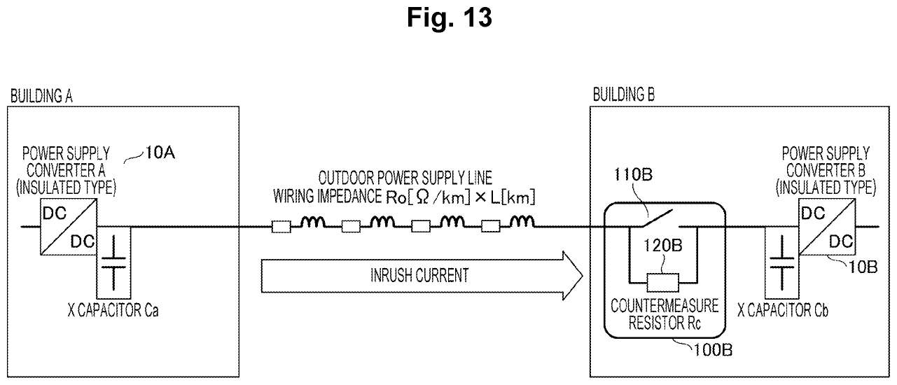

Here, an example of determining the necessity of the inrush current prevention apparatus 100B will be described using a DC power supply system illustrated in FIG. 13 as an example. In addition, a method of obtaining the value (here, Rc) of a resistor 120B will also be described. The determination and calculation here may be performed, for example, by the control apparatus 200 or may be executed by a computer other than the control apparatus 200. In any case of the control apparatus 200 and a computer other than the control apparatus 200, a device that performs the determination here may be referred to as determination device.

The determination device first determines whether or not it is necessary to suppress an inrush current by introducing the inrush current prevention apparatus 100B in the building B. Specifically, when the following Expression 1 is satisfied, it is determined that introduction of the inrush current prevention apparatus 100B is necessary.

$$- α ( Ro \times L ) + β < Cx \qquad Expression 1$$

When it is determined that it is necessary to introduce the inrush current prevention apparatus 100B, the determination device obtains the resistance value Rc for suppressing an inrush current by the following Expression 2.

$$Rc = γ \times ( Ro \times L ) \times [ Cx - \{ - α ( Ro \times L ) + β \} ] \qquad Expression 2$$

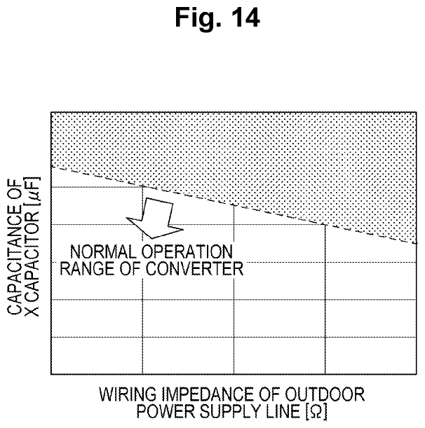

The meanings of the symbols in Expressions 1 and 2 are as follows.
α: a ratio [μF/km] of the capacitance of the X capacitor to the impedance (Ro×L) of the outdoor power supply line
β: the intersection of the dotted line and the y axis in FIG. 14 [μF]
γ: a constant associating the wiring impedance, the capacitance of the capacitor, and the countermeasure resistor
Cx: a smaller value of the capacitance Ca of the X capacitor and the capacitance Cb of the X capacitor of the actual power supply converter.

For Cx, for example, when Ca=3000 μF and Cb=1000 μF, Cx is 1000 μF.

FIG. 14 is a diagram illustrating a range in which a countermeasure is required, where the horizontal axis represents the wiring impedance of the outdoor power supply line and the vertical axis represents the capacitance of the X capacitor. The larger the capacitance of the X capacitor, the larger the inrush current, and the larger the wiring impedance, the larger the voltage drop with respect to the same current. Therefore, the range as illustrated in FIG. 14 is a range where countermeasures are required.

### (Hardware Configuration Example of Device)

Both the control apparatus 200 and the determination device can be implemented, for example, by causing a computer to execute a program. This computer may be a physical computer, or may be a virtual machine on a cloud. The control apparatus 200 and the determination device are collectively referred to as “device”.

Specifically, the device can be implemented by executing a program corresponding to the processing to be performed in the device, using hardware resources such as a CPU and a memory built in the computer. The above program can be stored and distributed by being recorded in a computer-readable recording medium (portable memory or the like). In addition, the program can also be provided through a network such as the Internet or an electronic mail.

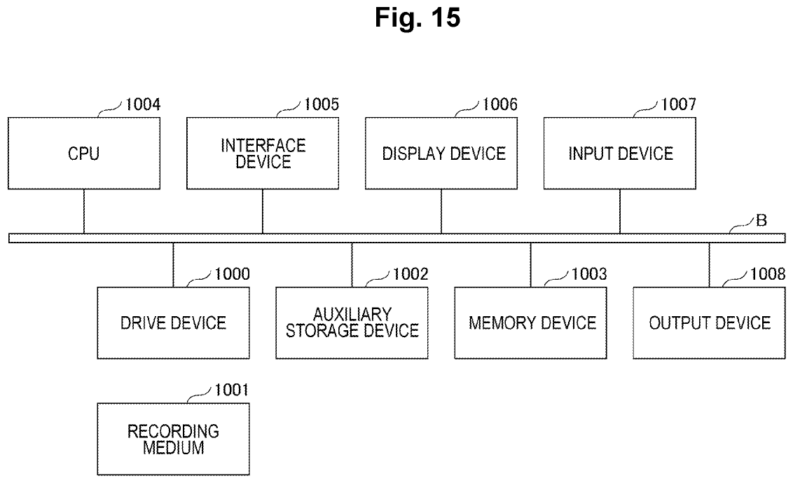

FIG. 15 is a diagram illustrating a hardware configuration example of the above computer. The computer in FIG. 15 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided by, for example, a recording medium 1001 such as a CD-ROM or a memory card. When the recording medium 1001 storing the program is set in the drive device 1000, the program is installed on the auxiliary storage device 1002 from the recording medium 1001 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program. The CPU 1004 implements a function related to the device in accordance with the program stored in the memory device 1003. The interface device 1005 is used as an interface for connection to a network, various measurement devices, and the like. The display device 1006 displays a graphical user interface (GUI) or the like according to the program. The input device 1007 includes a keyboard and a mouse, buttons, a touchscreen, or the like, and is used to input various operation instructions. The output device 1008 outputs a calculation result.

### Effects of Embodiments

With the technique according to the present embodiment, it is possible to prevent an inrush current in a DC power supply system in which a plurality of bases are connected by a power supply line.

More specifically, in the DC power supply system in which a plurality of bases are connected by a power supply line, when a power supply device is newly added to a trunk line in a power supply state, the peak current and the lower limit voltage of an inrush current are regulated, and a converter can normally start without having been stopped. In addition, the inrush current protection circuit can be shared to reduce the number of circuits.

### CLAUSES

In the present specification, at least an inrush current prevention apparatus, a control apparatus, and an inrush current prevention method in the following clauses are disclosed.

### (Clause 1)

An inrush current prevention apparatus used in a specific base in a DC power supply system, the DC power supply system including a plurality of bases, the plurality of bases each having a power supply device and being connected by a power supply line, the inrush current prevention apparatus including:
a switching unit configured to be in a connected state when the specific base is supplying power; and
a current reduction unit connected in parallel with the switching unit, in which
when a predetermined current has occurred between a power supply device in the specific base and a power supply device in another base, by bringing the switching unit into a disconnected state, a current between the power supply device in the specific base and the power supply device in the other base is caused to flow to the current reduction unit.

### (Clause 2)

The inrush current prevention apparatus according to Clause 1, in which
the predetermined current is an inrush current, and the inrush current is determined to have occurred when a current change amount equal to or larger than a threshold is detected by a current sensor provided in the specific base.

### (Clause 3)

The inrush current prevention apparatus according to Clause 1, in which
the inrush current prevention apparatus brings the switching unit into a disconnected state when power of a power supply device in a base other than the specific base is turned on.

### (Clause 4)

A control apparatus connected to the inrush current prevention apparatus according to any one of Clauses 1 to 3, the control apparatus including:
a determination unit configured to determine whether the predetermined current has occurred based on a measurement result of a current in the specific base; and
a control unit configured to bring the switching unit into a disconnected state when the determination unit determines that the predetermined current has occurred.

### (Clause 5)

An inrush current prevention method executed by an inrush current prevention apparatus used in a specific base in a DC power supply system, the DC power supply system including a plurality of bases, the plurality of bases each having a power supply device and being connected by a power supply line, the inrush current prevention method including:
bringing a switching unit into a connected state when the specific base is supplying power; and
when a predetermined current has occurred between a power supply device in the specific base and a power supply device in another base, bringing the switching unit into a disconnected state to cause a current between the power supply device in the specific base and the power supply device in the other base to flow to a current reduction unit connected in parallel with the switching unit.

While the present embodiment has been described above, the present invention is not limited to such a specific embodiment, and various modifications and changes can be made within the scope of the gist of the present invention described in the claims.

### REFERENCE SIGNS LIST

100 Inrush current prevention apparatus
110 Switching unit
111, 114 Transistor
113, 115 Diode
112, 116 Capacitor
120 Current reduction unit
130 Current sensor
200 Control apparatus
210 Measurement unit
220 Determination unit
230 Control unit
1000 Drive device
1001 Recording medium
1002 Auxiliary storage device
1003 Memory device
1004 CPU
1005 Interface device
1006 Display device
1007 Input device
1008 Output device

1. An inrush current prevention apparatus used in a specific base in a DC power supply system, the DC power supply system including a plurality of bases, the plurality of bases each having a power supply device and being connected by a power supply line, the inrush current prevention apparatus comprising:
a switching unit;
a current reduction unit connected in parallel with the switching unit;
a processor; and
a memory storing instructions that cause the processor to execute a process, the process including
bringing the switching unit into a connected state when the specific base is supplying power, wherein
when a predetermined current occurs between a power supply device in the specific base and a power supply device in another base, by bringing the switching unit into a disconnected state, a current between the power supply device in the specific base and the power supply device in the other base is caused to flow to the current reduction unit.

2. The inrush current prevention apparatus according to claim 1, wherein
the predetermined current is an inrush current, and the inrush current is determined to have occurred when a current change amount equal to or larger than a threshold is detected by a current sensor provided in the specific base.

3. The inrush current prevention apparatus according to claim 1, wherein
the process further includes bringing the switching unit into a disconnected state when power of a power supply device in a base other than the specific base is turned on.

4. A control apparatus connected to the inrush current prevention apparatus according to claim 1, the control apparatus comprising:
a processor; and
a memory storing instructions that cause the processor to execute a process, the process including
determining whether the predetermined current has occurred based on a measurement result of a current in the specific base; and
bringing the switching unit into a disconnected state when the determination unit determines that the predetermined current has occurred.

5. An inrush current prevention method executed by an inrush current prevention apparatus used in a specific base in a DC power supply system, the DC power supply system including a plurality of bases, the plurality of bases each having a power supply device and being connected by a power supply line, the inrush current prevention method comprising:
bringing a switching unit into a connected state when the specific base is supplying power; and
bringing the switching unit into a disconnected state to cause a current between a power supply device in the specific base and a power supply device in another base to flow to a current reduction unit connected in parallel with the switching unit when a predetermined current has occurred between the power supply device in the specific base and the power supply device in the other base.
